(19) United States
(12) Patent Application Publication
(10) Pub. No.: US 2015/0147473 A1
(43) Pub. Date: May 28, 2015

(54) AIRBRUSH EFFECT SYSTEM

(71) Applicant: David Tse, Flushing, NY (US)

(72) Inventor: David Tse, Flushing, NY (US)

(21) Appl. No.: 14/551,640

(22) Filed: Nov. 24, 2014

Related U.S. Application Data
(60) Provisional application No. 61/907,595, filed on Nov. 22, 2013.

(51) Int. Cl. B43K 8/00; B43K 8/02; B43K 23/008; B43K 8/03

(52) U.S. Cl. CPC B43K 8/006; B43K 8/03; B43K 8/02; B43K 23/008
USPC 427/256; 239/418; 239/408; 239/346

(57) ABSTRACT

An airbrush system includes a compressor with a tube attached thereto to provide air to an airbrush that includes an adaptor to mount a marker or ink supply on the airbrush in front of the outlet air nozzle thereof. As the air passes over the marker or other ink supply, it drives ink outward to reproduce the airbrush effect.

### CROSS-REFERENCE TO RELATED APPLICATIONS

The present application claims benefit of and priority to U.S. Provisional Patent Application Ser. No. 61/907,595 filed Nov. 22, 2013 entitled AIRBRUSH SYSTEM, the entire content of which is hereby incorporated by reference herein.

### BACKGROUND

1. Field of the Disclosure

The present disclosure relates to an airbrush effect system that uses markers and/or another ink, paint or colored fluid source positioned outside an airbrush or other air directing element and downstream of the outlet air nozzle thereof. More specifically, the present disclosure relates to an airbrush effect system including an adaptor configured to receive a specific ink or paint source and position the source at a predetermined position downstream from the air nozzle of an air directing implement to provide an airbrush like effect on a medium to be painted or decorated.

2. Related Art

Airbrushing is a common technique to provide a unique look to artwork. Airbrush systems typically include a compressor, a length of tubing to conduct air from the compressor to the airbrush to which the length of tubing is connected. The air forces paint that is fed into the airbrush through the airbrush and out an outlet air nozzle toward a medium to be painted. A paint reservoir is typically attached to the airbrush and the paint is fed into the airbrush body. Since the paint is drawn into the airbrush itself, the airbrush must be rinsed out after each use and also in order to change colors. Further, the compressor tends to be relatively large and difficult to move, such that conventional airbrush systems are difficult to move.

Accordingly, it would be desirable to provide an airbrush system that avoids these and other problems.

### SUMMARY

It is an object of the present disclosure to provide an airbrush effect system that is usable with a marker or other ink source positioned downstream of an outlet air nozzle of the airbrush. The airbrush effect system preferably includes a compact and relatively portable compressor, a length of tubing connected to the compressor and configured to carry air from the compressor to an airbrush, or other air-directing device or implement, connected to the tubing. Preferably, a marker or other ink source is attached to the airbrush and positioned downstream of an output air nozzle thereof such that air flowing out of the nozzle carries the ink to the medium to be decorated.

An airbrush system in accordance with an embodiment of the present application includes an air directing implement including an inlet configured to be connected to a source of pressurized air and an outlet configured to direct air from the source of pressurized air out in a desired direction. Preferably, at least one adaptor is configured to receive the air directing implement and an ink source to position the ink source at a predetermined position defined by a predetermined distance from and a predetermined angle relative to the outlet of the air directing implement.

An airbrush system in accordance with an embodiment of the present application includes an air directing implement including an inlet configured to be connected to a source of pressurized air and an outlet configured to direct air from the source of pressurized air in a desired direction. The air directing implement is preferably configured to receive and position different types of ink sources at a predetermined position defined by a predetermined distance from and a predetermined angle relative to the outlet of the air directing implement.

A method of applying a colored fluid to a medium to provide an airbrush effect in accordance with an embodiment of the present application includes using an air directing implement including an inlet configured to be connected to a source of pressurized air and an outlet to direct air in a desired direction and connecting a first adaptor to a first end of the air directing implement including the outlet, the first adaptor receiving and positioning a first ink source at a predetermined position defined by a predetermined distance from and a predetermined angle with respect to the outlet of the air directing implement.

### BRIEF DESCRIPTION OF THE DRAWINGS

FIG. 1 illustrates an airbrush effect system in accordance with an embodiment of the present application.

FIG. 2 is a top view of an exemplary embodiment of an airbrush for use with the airbrush effect system of FIG. 1.

FIG. 3 is a side view of the airbrush of FIG. 2.

FIG. 4 illustrates an exemplary embodiment of an airbrush and adaptor for a marker suitable for use in the airbrush effect system of FIG. 1.

FIG. 5A illustrates an exemplary embodiment of a siphon adaptor in use with an airbrush in the airbrush effect system of FIG. 1.

FIG. 5B illustrates the siphon adaptor of FIG. 5A in more detail.

FIG. 6A illustrates an exemplary embodiment of an airbrush effect system including a compressor illustrating the airbrush received on the compressor.

FIG. 6B illustrates top and side views of the system of FIG. 6A.

FIG. 7A illustrates a top view of the system of FIGS. 6A-6B with a cutaway showing a motor of the compressor.

FIG. 7B is a side view of the system of FIGS. 6A-6B with a cutaway showing the motor of the compressor.

FIG. 7C is a front view of the system of FIGS. 6A-6B with a cutaway showing the motor of the compressor.

FIG. 7D is a rear view of the system of FIGS. 6A-6B with a cutaway showing the motor of the compressor.

FIG. 7E is a bottom view of the system of FIGS. 6A-6B.

FIG. 8 illustrates a perspective view of an airbrush fitted with an exemplary embodiment of a siphon adaptor and an ink or paint source suitable for use in the airbrush effect system of FIG. 1.

FIG. 9 illustrates a cross-sectional view of the siphon adaptor and the ink or paint source of FIG. 8.

FIG. 10 illustrates an airbrush fitted in the exemplary embodiment of the siphon adaptor of FIG. 8 with another exemplary embodiment of an ink or paint source suitable for use in the airbrush effect system of FIG. 1.

FIG. 11 illustrates a cross-sectional view of the siphon adaptor and the ink or paint source of FIG. 10.

FIG. 12 is a more detailed view of the siphon adaptor illustrated in FIGS. 8-11.

FIG. 13 is a more detailed view of an exemplary embodiment of a cap element used with the siphon adaptor illustrated in FIGS. 8-11.

FIG. 14 illustrates a more detailed view of the nozzle provided as an outlet for ink or paint from an ink or paint source such as those illustrated in FIGS. 8-11.

FIG. 15 illustrates a more detailed view of a ball joint in which the nozzle of FIG. 14 is mounted.

FIG. 16 illustrates a more detailed view of the ink or paint source illustrated in FIGS. 10-11

FIG. 17 illustrates a more detailed view of the cap element of the ink or paint source of FIG. 16.

FIG. 18 illustrates a more detailed view of a reservoir portion of the ink or paint source of FIG. 16.

FIG. 19 is a cross sectional view of the nozzle of FIG. 14 mounted in the ball joint of FIG. 15 secured by the cap element of FIG. 13 on the adaptor of FIG. 12.

FIG. 20 is a more detailed view of the nozzle of FIG. 14 mounted in the ball joint of FIG. 15 and a detailed view of the threads formed on a bottom of the nozzle in FIG. 14.

Other features and advantages of the present invention will become apparent from the following description of the invention which refers to the accompanying drawings.

### DETAILED DESCRIPTION OF THE EMBODIMENTS

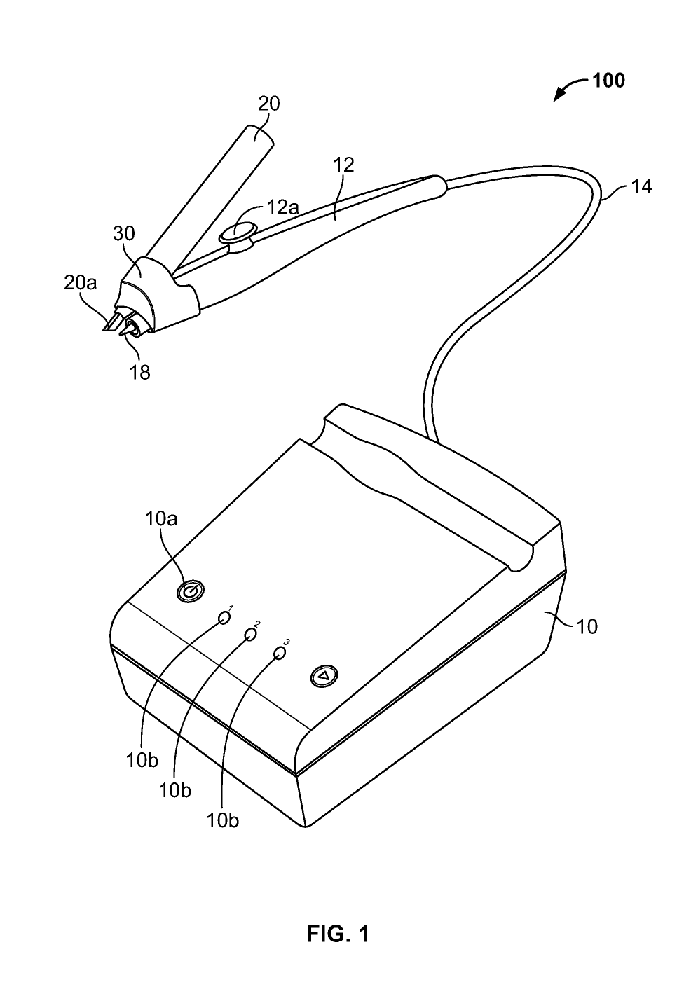

FIG. 1 illustrates an airbrush effect system 100 in accordance with an embodiment of the present disclosure. The airbrush system 100 preferably allows a user to provide an airbrush effect without the complications of use required by conventional airbrushes identified above. The system 100 preferably includes a marker adaptor 30 that positions a marker 20 (an ink source) in front of an outlet air nozzle 18 of the airbrush element 12. The flow of air across the nib 20a of the marker 20 propels ink from the marker to provide the desired airbrush effect on a work piece. The marker 20 is a marker type writing implement typically used in crafts and art. In another embodiment, the system 100 uses a siphon adaptor 130, 230 to position a liquid ink or paint source 232, 332 in front of the nozzle 18 of the airbrush 12 to provide the same airbrush effect. While the present disclosure refers to airbrush 12, element 12 may be any suitable air directing device or implement that directs air in a desired direction.

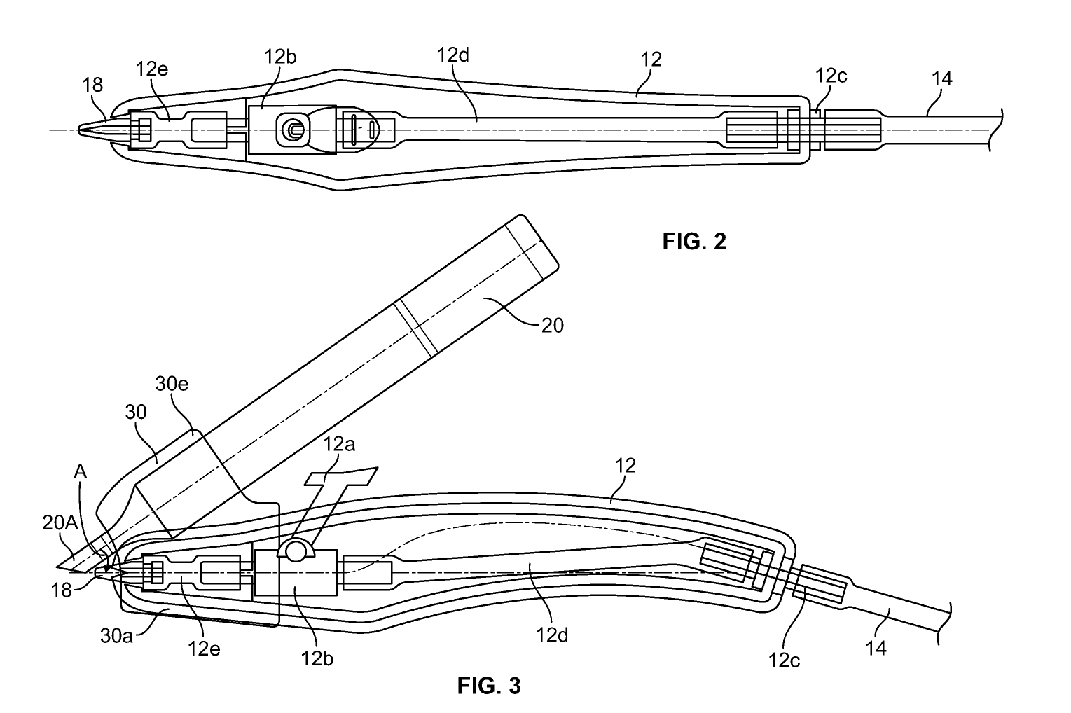

The airbrush 12 is preferably ergonomically designed to fit comfortably in the hand of a user, thus reducing fatigue. FIGS. 2-3 illustrate top and side views, respectively, of an exemplary embodiment of such an airbrush 12. The airbrush 12 is preferably a double action airbrush that is connected to an air compressor 10 via the tube 14, for example. A double action airbrush is preferable to prevent air from being expelled when the trigger 12a is not depressed. The trigger 12a, preferably controls a valve (not shown) in a valve element 12b inside the airbrush 12 to enable, or cut off the flow of air through the airbrush 12 and out the nozzle 18. In the closed position, the valve blocks air from exiting via nozzle 18. In the open position, the valve allows air to flow to and out the nozzle 18.

Unlike a traditional airbrush, the airbrush 12 does not need paint or ink to enter the airbrush upstream of the outlet air nozzle 18. That is, paint or ink does not need to enter the airbrush body itself. Therefore, the airbrush 12 never needs to be cleaned. The air pressure out of the airbrush 12 may be adjusted by changing the diameter of the outlet opening of nozzle 18. The smaller the opening, the higher the air pressure of the stream of air exiting the airbrush 12. The airbrush 12 produces enough pressure to drive ink from the marker 20 in the same manner and to provide the same effect as a traditional airbrush. While the terms ink and paint are used above, the airbrush 12 may be used with any source of ink, paint or other colored fluid to provide the airbrush effect. As used herein the terms “ink” and “paint” apply to any colored fluid, including but not limited to ink, paint, or even water and food coloring.

The front end of the airbrush 12 preferably includes, or is connected to, an adaptor or receiver 30 configured to receive the marker 20 such that the nib 20a thereof is positioned adjacent and downstream from the nozzle 18. FIGS. 2-4 illustrate exemplary embodiments of an airbrush 12 suitable for use in the system 100. In these embodiments, the airbrush 12 has an elongated pen-type shape, however, the airbrush 12 of the present application is not limited to this shape. In a preferred embodiment, as illustrated in FIG. 3, for example, the airbrush 12 is connected to tube 14 which provides air from a pressurized air source, such as the compressor 10 (see FIG. 1, for example). An air adaptor 12c or other inlet may be provided at a rear of the airbrush 12 and coupled to the end of the hose 14. The air adaptor 12c is preferably hollow or includes a hollow portion to allow the air from the tube 14 to enter the airbrush 12, specifically into intermediate member 12d. If desired, the tube 14 may enter the airbrush itself and connect to the intermediate member 12d, or the valve element 12b, directly. Air in the intermediate member 12d preferably flows into valve element 12b. If the valve is open, the air passes through the valve element 12b. If the valve is closed, the air is blocked from passing through the valve element 12b. The state of the valve, open or closed, in the valve element 12b is preferably based on operation of the trigger 12a, which is actuated by the user. After exiting the valve element 12b, air preferably enters the nozzle connector 12e, which provides the air to outlet nozzle 18, which directs the air out of the airbrush 12 in a desired direction. If desired, the nozzle 18 may be directly connected to valve member 12b. The air path through the airbrush 12 is preferably airtight such that all of the air that is provided to the airbrush 12 via hose 14 stays in the airbrush, unless it exits via the outlet valve 18.

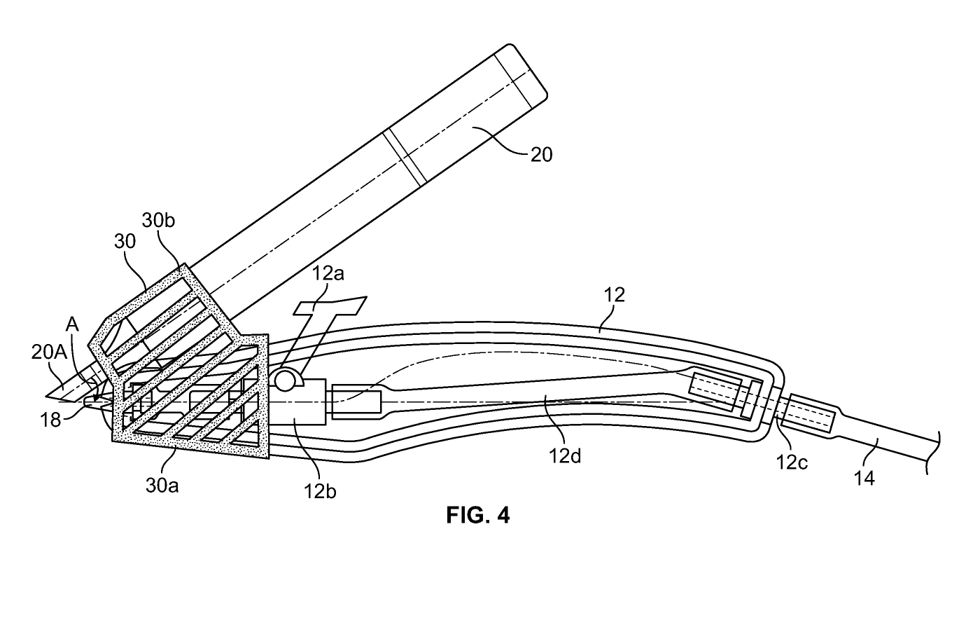

The adaptor 30 preferably securely holds the marker 20. The adaptor 30 may be configured to accommodate a marker of any desired make or model. In a preferred embodiment, the system 100 may include or be compatible with a plurality of different adaptors 30, each of which, is sized to hold a specific brand, or type of marker. In each case, the adaptor 30 preferably fits over or around the front of the airbrush 12, where the nozzle 18 is positioned. That is, a first portion 30a of the adaptor 30 is sized to accommodate or receive the airbrush 12, as shown in FIGS. 3 and 4, for example. That is, the first portion 30a preferably includes an opening that is sized and shaped to allow at least a front end of the airbrush 12 to pass therethrough and to contact the airbrush at a desired point. A marker 20 is preferably inserted into the adaptor 30, specifically into a second portion 30b thereof. This second portion 30b is preferably configured to receive the marker 20 and position the nib 20a of the marker 20 at the optimal angle and distance with respect to the nozzle 18 such that airflow from the airbrush 12 will hit the nib, allowing ink to be sprayed in the same manner as a traditional airbrush spray. That is, the second portion 30b preferably includes an opening sized and shaped to receive a nib end of marker 20 and to contact the marker at a desired position to secure it relative to the airbrush 12. This is illustrated graphically in FIGS. 1 and 3-4. In an embodiment, the distance between the nozzle 18 and the nib 20a is between 0.5 and 5.5 mm. Further, in a preferred embodiment, the angle A (See FIG. 3, for example) between the central axis of the airflow from the nozzle 18 and the central axis of the marker 20 and nib 20a is between 20 and 60 degrees. Different distances and angles may be optimal for different markers. The distance and angle are provided such that the stream of air from the nozzle 18 drives ink from the nib 20a of the marker 20. The adaptor 30 is configured for optimizing the position of a specific make or model of marker. The marker adaptor 30 may be molded or retrofitted to any airbrush device. As noted above, in a preferred embodiment, different adaptors 30 are provided with or available for use with the system 100 to accommodate different markers 20. FIG. 3 illustrates the adaptor 30 with the outer surface thereof shown as translucent so that the marker 20 and the body of the airbrush 12 is visible.

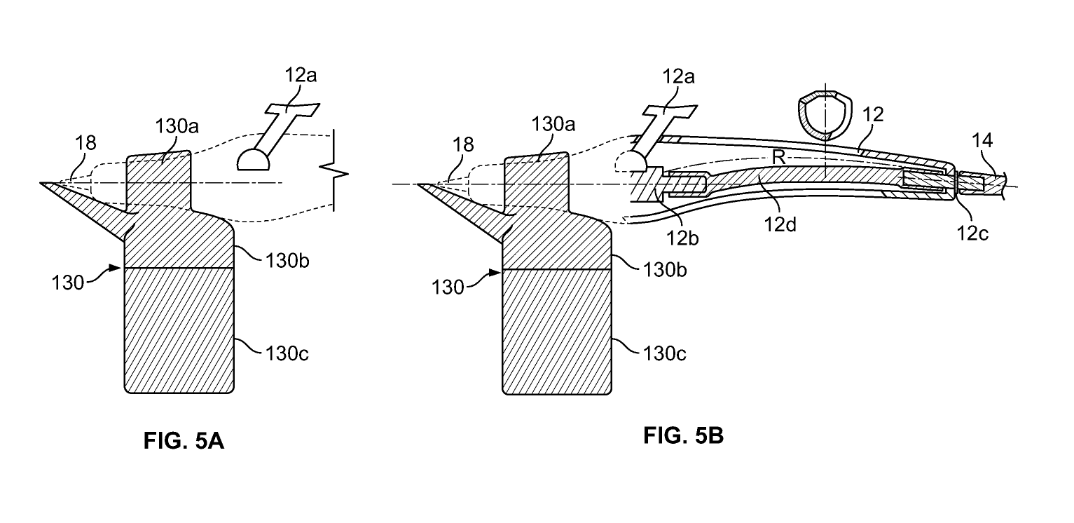

In an embodiment, a siphon adaptor 130 may be used with the airbrush 12. The adaptor 130 preferably fits over or on an end of the airbrush 12 in much the same manner as the adaptor 30 discussed above. That is, a first element 130a, thereof, receives the airbrush 12. A jar or container 130c may be screwed or otherwise secured to a second element 130b of the adaptor 130, allowing it to sit in front of and preferably below the nozzle 18 of the airbrush 12. The container 130c preferably includes a liquid supply of ink, paint or other colored fluid. Inside the adaptor 130, a wick may be provided to absorb the ink, paint or other colored fluid, from the jar 130c. The ink is absorbed up a channel that leads toward the tip of the nozzle 18 of the airbrush 12. When the airbrush 12 is activated, by depressing trigger 12a, for example, the stream of air directed from the nozzle 18 will pass over the top of the container 130c to create a siphon effect. The pressure in the jar 130c will increase relative to the air pressure at the exit thereof, causing the ink to rise up the jar to the wick and out of the container to create an airbrush effect/spray. FIGS. 5A-5B illustrate exemplary embodiments of the siphon adaptor 130 suitable for use with the airbrush 12 of FIGS. 2-4 and the system 100 of FIG. 1.

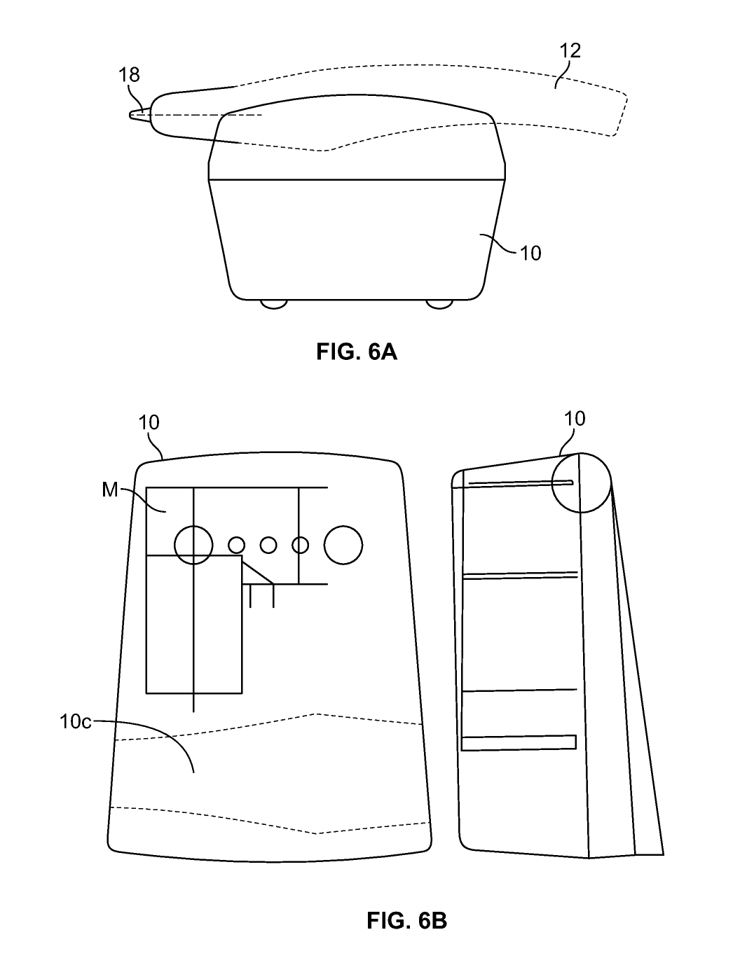

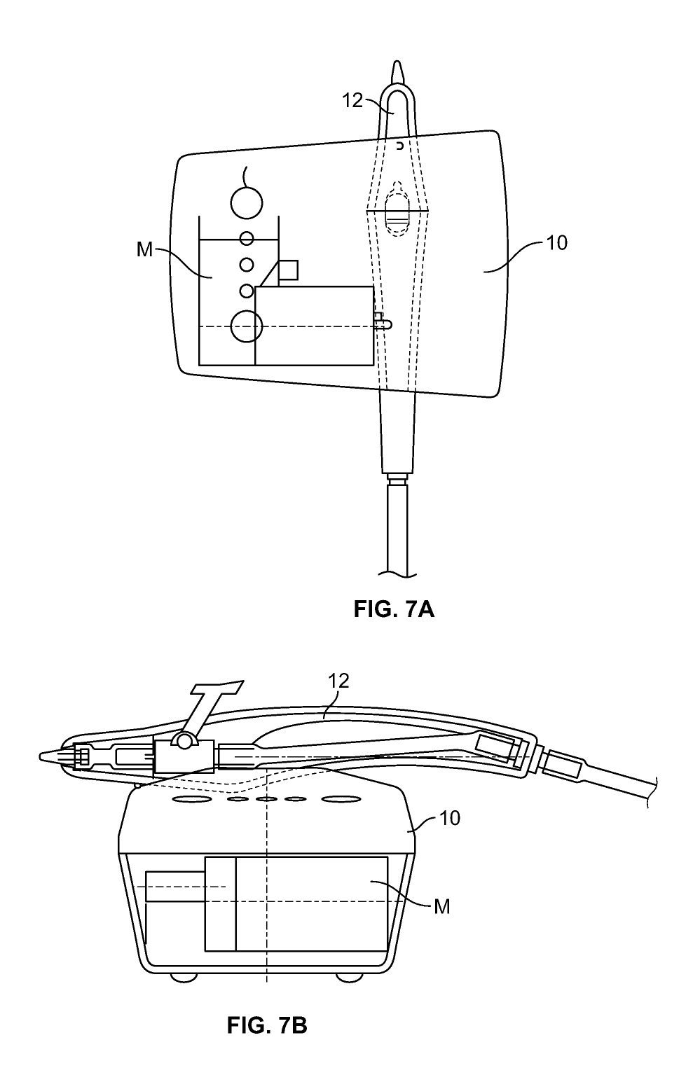

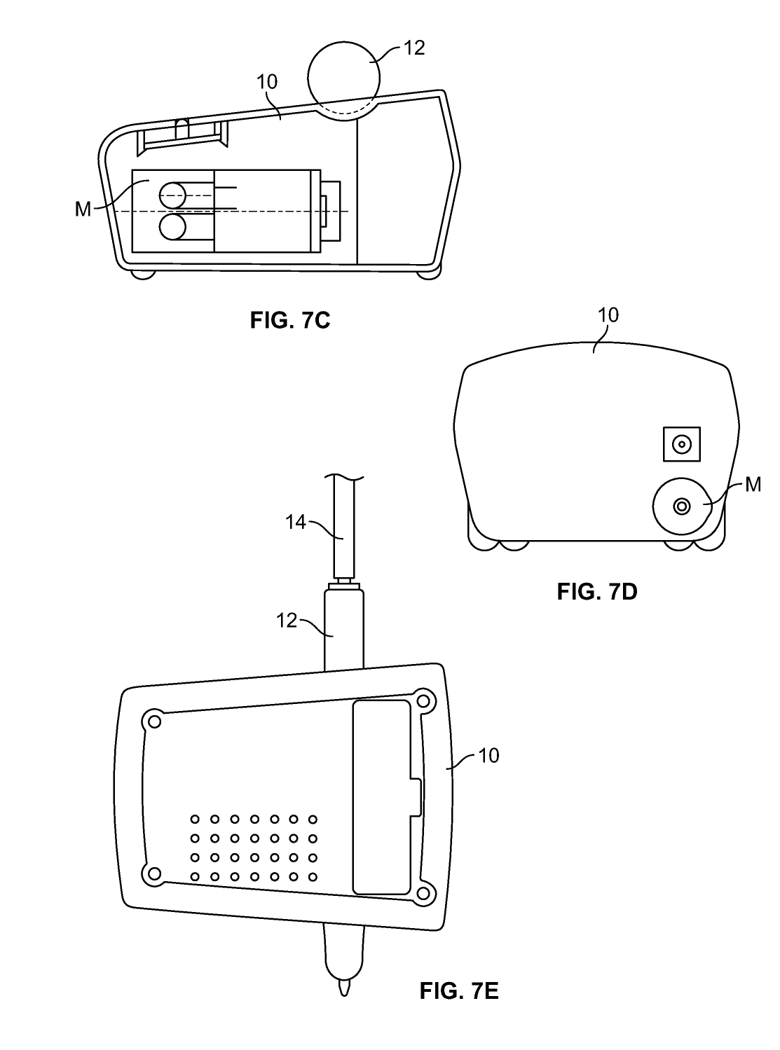

In a preferred embodiment, pressurized air is provided to the airbrush 12 via hose 14 by an air source, such as the miniature air compressor 10 illustrated in FIG. 1, for example. While the compressor 10 is illustrated, any suitable source of pressurized air may be used. In this embodiment, the compressor 10 is preferably electronically controlled to provide different pressure settings. In an embodiment, the compressor includes an on/off switch 10a and speed control buttons 10b that can be used to change the speed of the motor M used therein. Changing the speed of the motor M also changes the pressure of the air provided to the airbrush 12, and thus, effects the air pressure of the air exiting the airbrush as well. The air compressor 10 may be powered by AC power, from a wall outlet, for example, or DC power, from a battery or batteries, for example. In an embodiment, the compressor 10 is configured to allow the airbrush 12 to rest on a top surface thereof. This provides for easy storage of and access to the airbrush 12. FIGS. 6A-6B illustrate an exemplary embodiment of the airbrush resting on a compressor 10. FIGS. 7A- 7E show compressor 10 holding the airbrush 12 from different views. In FIGS. 7A-7E, portions of the cover of the compressor 10 are cut away, or transparent, to illustrate the motor M used in the compressor. The cover of the compressor 10 preferably includes a receiving recess 10c on a top surface thereof to accommodate the airbrush 12. The compressor 10 is connected to the airbrush 12 via hollow tube, or hose 14 through which air flows from the compressor to the airbrush.

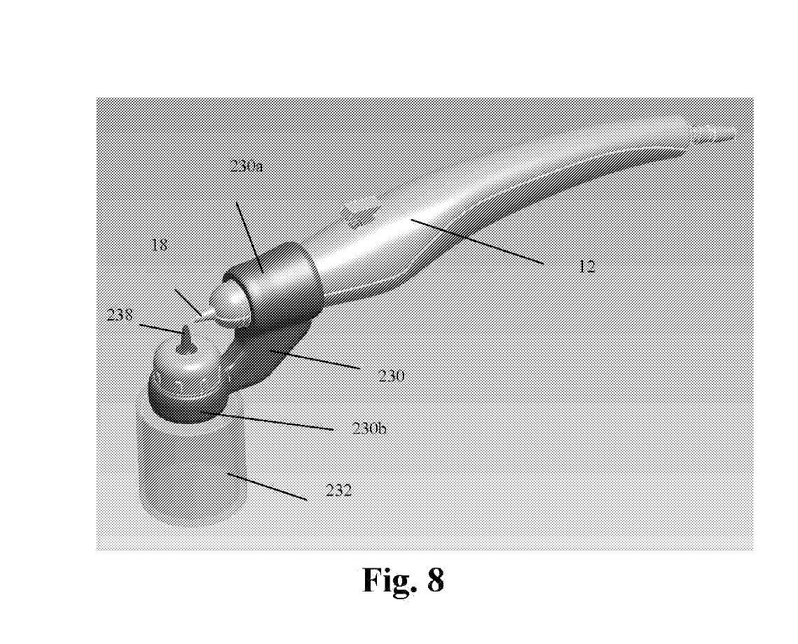

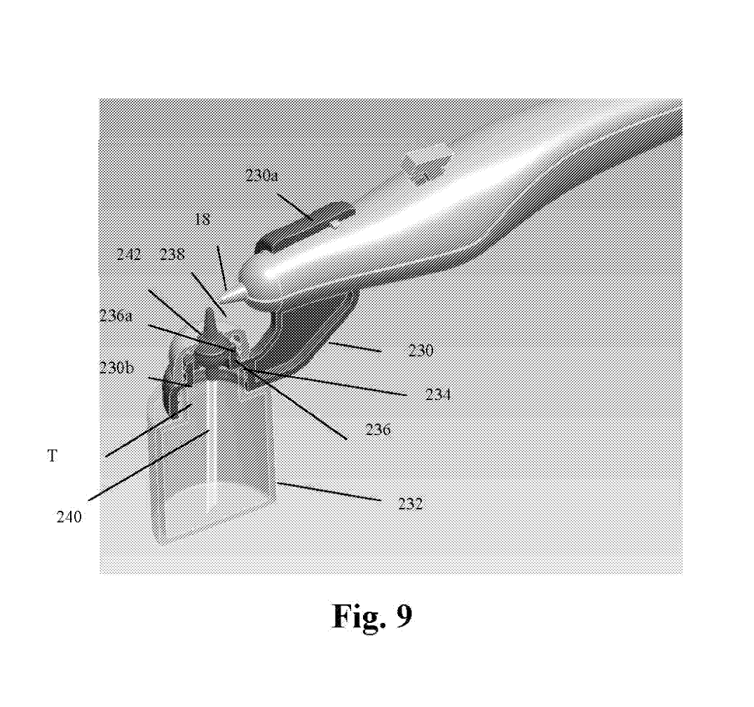

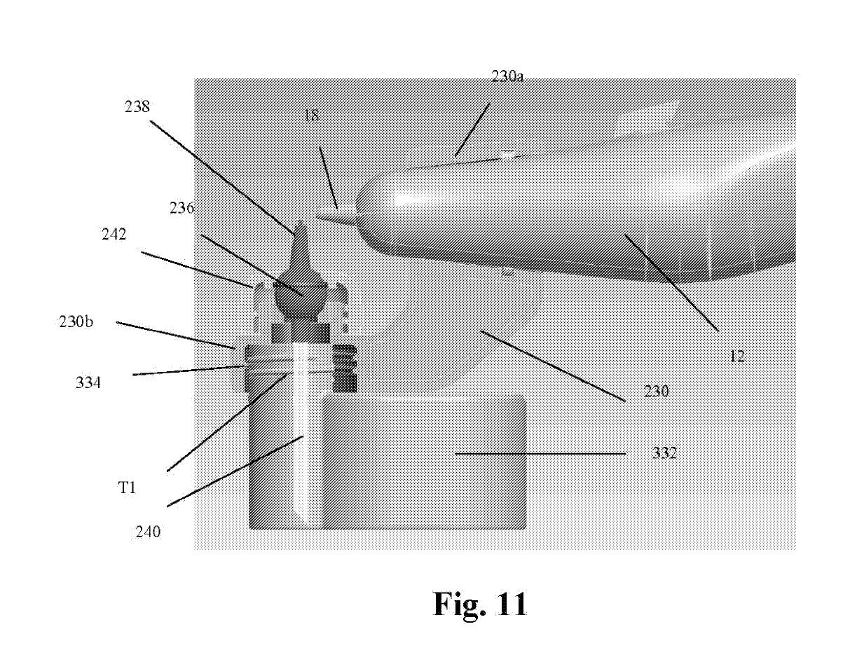

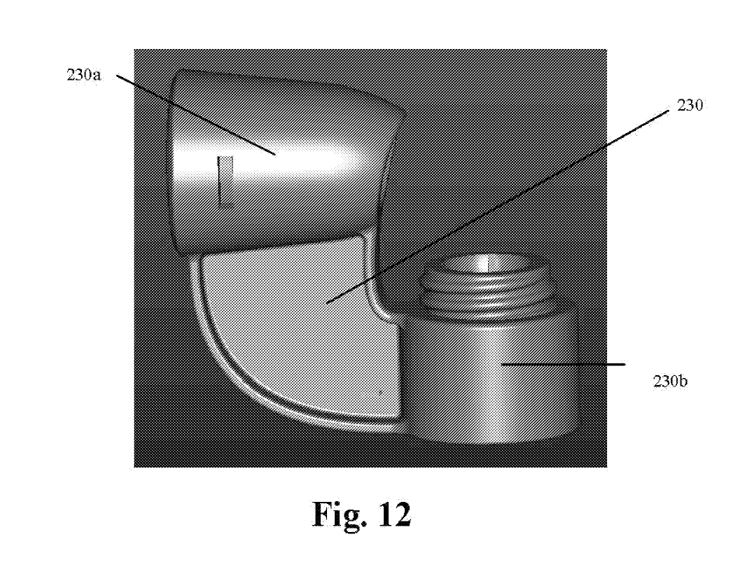

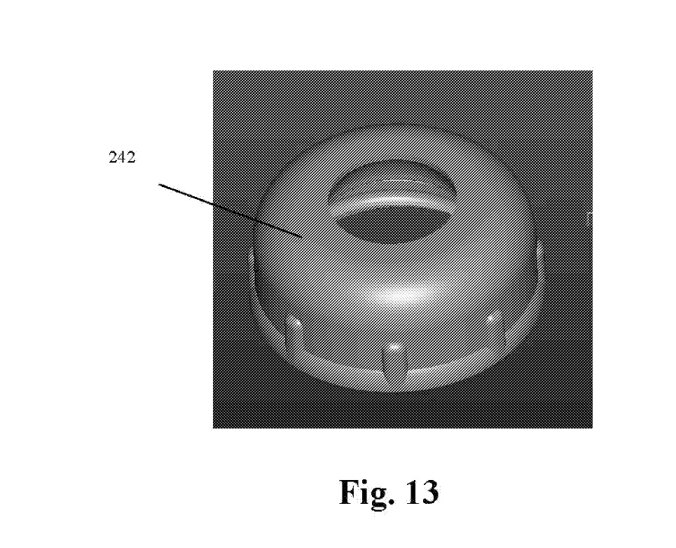

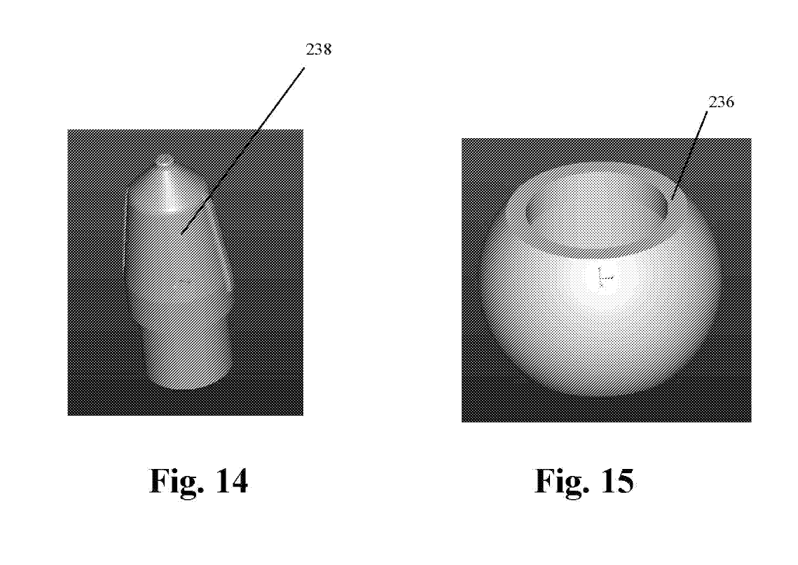

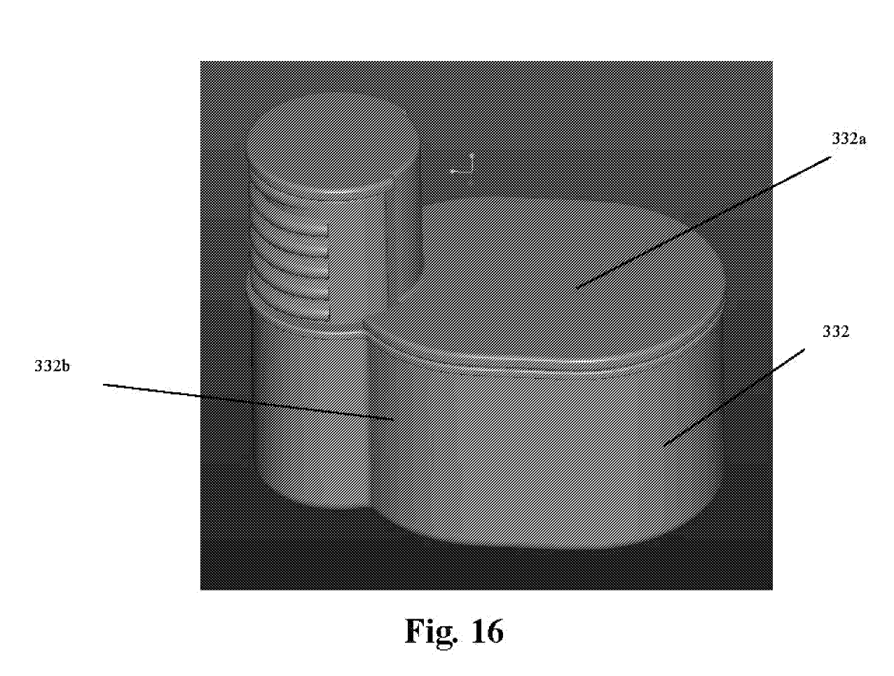

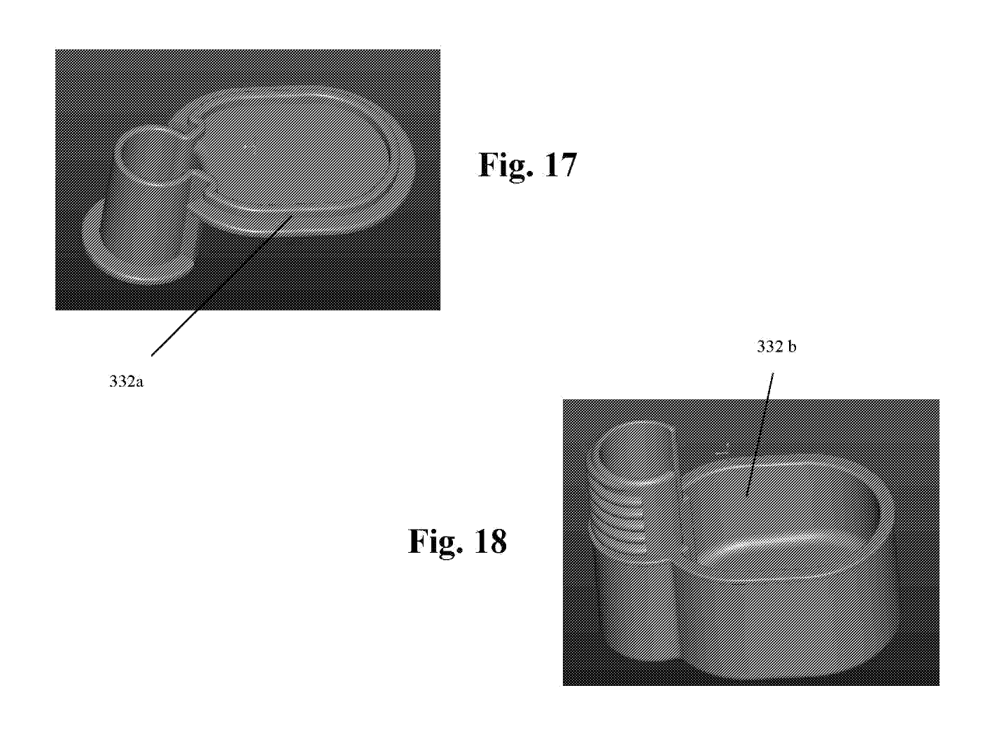

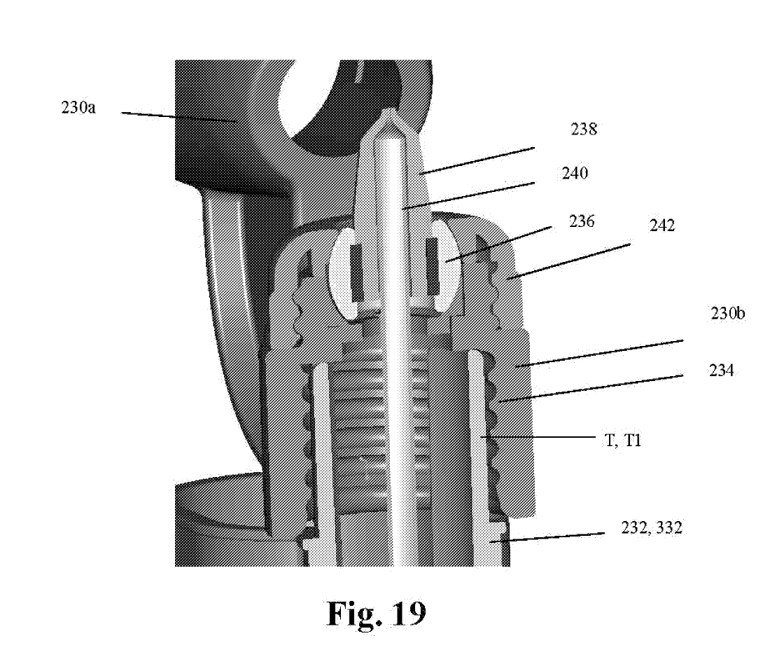

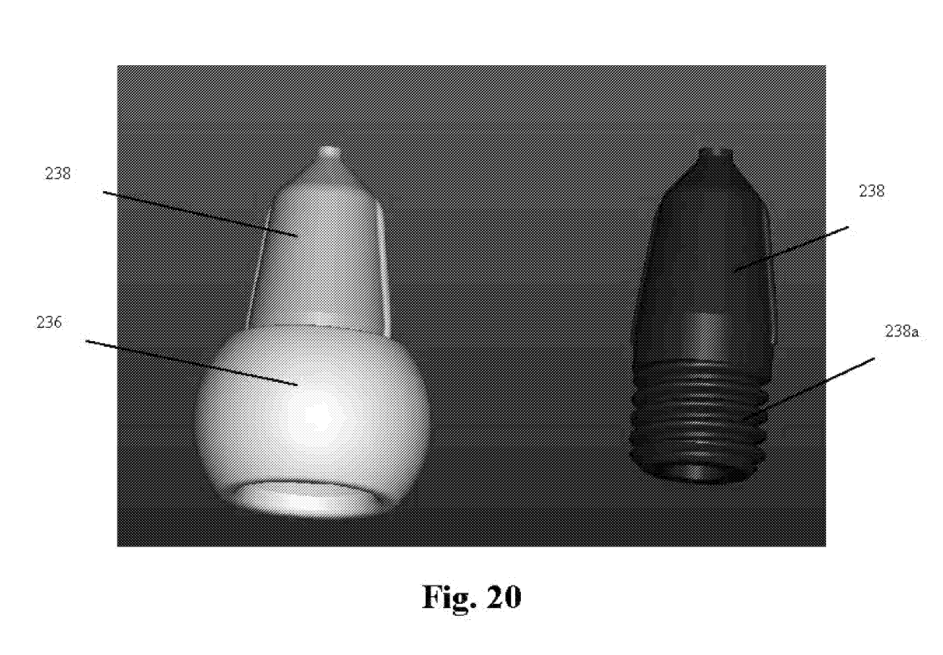

FIG. 8 illustrates another embodiment of a siphon adaptor 230 connected to an airbrush 12. The first portion 230a of the siphon adaptor 230 preferably fits over or is otherwise attached to the end of the airbrush 12. The second portion 230b preferably interacts with a container 232, which preferably holds liquid ink, paint or another colored fluid. Specifically, as illustrated in FIG. 9, the second portion 230b of the siphon adaptor 230 may have a ring shape with threads 234 formed on the inner surface thereof. These threads 234 may interact with the threads T formed on the neck of container 232 to secure the adaptor 230 to the container. While threads are illustrated in FIG. 9, any suitable connector may be used to connect the second part 230b of the adaptor 230 to the container 232 and any shape may be used. A ball joint 236 is preferably mounted in the neck of the bottle 232 with a nozzle 238 preferably movably mounted therein. The ball joint 236 preferably includes an opening into the interior of container 232, which preferably aligns with a flow path through the nozzle 238 (see FIG. 19, for example). FIG. 16 illustrates a more detailed view of the nozzle 238 and FIG. 17 illustrates a more detailed view of the ball joint 236. A tube 240 may be mounted in or through the ball joint 236 and extends down into the interior of the container 232. The top of nozzle 238 is preferably positioned a desired distance away from and downstream from outlet nozzle 18 of the airbrush 12. This distance is preferably between 0 and 4 mm. Further, the top of the nozzle 238 is preferably positioned at a desired angle with respect to the outlet nozzle 18 of the airbrush 12. This angle is preferably approximately 90 degrees, and the nozzle 238 is preferably adjustable 0-4 degrees relative to the central axis of the container 232, in a direction toward the nozzle 18. As the stream of air from the outlet nozzle 18 passes over the top of the nozzle 238, the pressure inside the container 232 rises relative to the pressure at top of nozzle 238 such that the colored fluid in the container 232 travels up the tube 240 and out of the nozzle 238 where the stream of air from the nozzle 18 drives the ink, paint or other colored fluid to provide the airbrush effect. In a preferred embodiment, the nozzle 238 may be adjusted upward and downward in the in the ball joint 236, as desired. The nozzle 238 may include threads 238a (see FIG. 20) on a bottom portion thereof to allow for up and down adjustment in the ball joint 236. The diameter of the opening in the nozzle 238 may also be varied to provide different ink patterns, as desired. In addition, the ball joint 238 allows for the nozzle to rotate relative to the central vertical axis of the container such that the angle between the nozzle 18 of the airbrush 12 and the top of the nozzle 238 may be adjusted. A ball joint cap 242 is screwed onto the top of the portion 230b of the siphon adaptor 230 to hold the ball joint 236 and nozzle 238 in place on top of the container 232. The cap 242 is illustrated in more detail in FIG. 13. The cap 242 also forms a seal with the ball joint 236 to prevent air or liquid from escaping the container 232 other than from the nozzle 238. As shown in FIG. 11, for example, this seal is preferably formed between the inner surface of the cap 242 and a seal lip 236a extending from the ball joint 236.

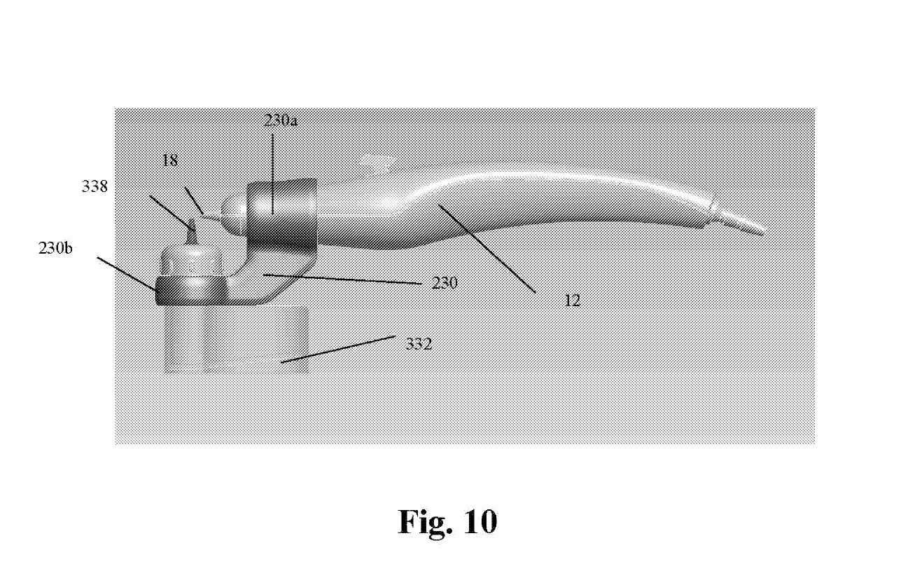

FIG. 10 illustrates the siphon adaptor 230 in use with airbrush 12 and an alternative embodiment of a container 332 that holds ink, paint or other colored fluid. The adaptor 230 is the same as that illustrated in FIGS. 8-9 and interacts with the container 332 in the same manner including the use of the ball joint 236, the nozzle 238 and the cap 242. As illustrated in FIG. 11, for example, the container 332 preferably includes threads T1 that interact with the threads 234 of the adaptor 230. FIG. 16 illustrates a more detailed view of the container 332. The container 332 preferably includes a cap section 332a (see FIG. 17) that covers a reservoir section 332b (see FIG. 18) in which the ink, paint or other colored fluid is stored. It is noted that the cap section 332a is removed from the reservoir element 332b prior to attachment to the adaptor 230. Otherwise the operation of the airbrush 12, the adaptor 230 and the container 332 is substantially the same as that described above with respect to the container 232.

Although the present invention has been described in relation to particular embodiments thereof, many other variations and modifications and other uses will become apparent to those skilled in the art.

What is claimed is:

1. An airbrush system comprising:
an air directing implement including an inlet configured to be connected to a source of pressurized air and an outlet configured to direct air from the source of pressurized air out in a desired direction; and
at least one adaptor configured to receive the air directing implement and an ink source to position the ink source at a predetermined position defined by a predetermined distance from and a predetermined angle relative to the outlet of the air directing implement.

2. The airbrush system of claim 1, wherein the air directing implement further comprises:
an outlet nozzle positioned at the outlet configured to direct a stream of air out of the air directing implement in the desired direction; and
a valve element positioned upstream from the outlet nozzle and moveable between an open position in which air is directed to the outlet nozzle and a closed position in which air is blocked from the outlet nozzle.

3. The airbrush system of claim 2, wherein the air directing implement further comprises an actuator connected to the valve element and configured to move the valve element from the closed position to the open position.

4. The airbrush system of claim 1, wherein the at least one adaptor further comprises a first element including a first opening formed therein to receive a first end of the air directing implement including the outlet thereof.

5. The airbrush system of claim 1, wherein the first opening receives the first end of the air directing implement such that the first element contacts the air directing implement at a predetermined position.

6. The airbrush system of claim 4, wherein the ink source is a marker.

7. The airbrush system of claim 6, wherein the at least one adaptor further comprises a second element including a second opening formed therein and shaped to receive the marker.

8. The airbrush system of claim 7, wherein the at least one adaptor is configured to position a nib of the marker at the predetermined distance from the outlet of the air directing implement such that air exiting the air directing implement passes over at least a portion of the nib of the marker.

9. The airbrush system of claim 7, wherein the at least one adaptor is configured to position a nib of the marker at the predetermined distance from the outlet of the air directing implement and at the predetermined angle relative to the outlet such that air exiting the air directing implement passes over at least a portion of the nib of the marker at a desired angle.

10. The airbrush system of claim 7, wherein the second opening is provided with a predetermined shape to accommodate the marker.

11. The airbrush system of claim 10, wherein the predetermined shape of the second opening is selected based on a configuration of the marker.

12. The airbrush system of claim 4, wherein the ink source is a container including a colored fluid.

13. The airbrush system of claim 12, wherein the at least one adaptor further comprises a second element including a first mating element.

14. The airbrush system of claim 13, wherein the container includes a second mating element configured to interact with the first mating element of the second element of the at least one adaptor to connect the container to the at least one adaptor.

15. The airbrush system of claim 14, wherein the second element of the at least one adaptor is ring shaped and the first mating element is a thread formed on an inner surface of the ring shape.

16. The airbrush system of claim 15 wherein the container includes a cylindrical neck and the second mating element is a second thread formed around the cylindrical neck.

17. The airbrush system of claim 12, further comprising:
a nozzle mounted at a top of the container and in fluid communication with an interior of the container, the nozzle positioned at the predetermined distance from the outlet of the air directing implement such that air exiting the outlet passes adjacent to the nozzle.

18. The airbrush system of claim 12, further comprising:
a nozzle mounted at a top of the container and in fluid communication with an interior of the container, the nozzle positioned at the predetermined distance from the outlet of the air directing implement and movable with respect to the container to adjust an angle between the nozzle and the outlet of the air directing implement such that air exiting the outlet passes adjacent to the nozzle at a desired angle.

19. The airbrush system of claim 17, wherein the nozzle is movable to adjust a height of a top of the nozzle relative to the outlet of the air directing implement.

20. The airbrush system of claim 17, where the nozzle is rotatable relative to a central axis of the container to change the angle between the nozzle and the outlet of the air directing implement.

21. The airbrush system of claim 12, further comprising a tube connected to the nozzle and extending into the container.

22. The airbrush system of claim 21, wherein the colored fluid in the container travels up the tube to the nozzle when the air passes adjacent to the nozzle.

23. An airbrush system comprising:
an air directing implement including an inlet configured to be connected to a source of pressurized air and an outlet configured to direct air from the source of pressurized air in a desired direction;
the air directing implement configured to receive and position different types of ink sources at a predetermined position defined by a predetermined distance from and a predetermined angle relative to the outlet of the air directing implement.

24. A method of applying a colored fluid to a medium to provide an airbrush effect comprises:
using an air directing implement including an inlet configured to be connected to a source of pressurized air and an outlet to direct air in a desired direction; and
connecting a first adaptor to a first end of the air directing implement including the outlet, the first adaptor receiving and positioning a first ink source at a predetermined position defined by a predetermined distance from and a predetermined angle with respect to the outlet of the air directing implement.

25. The method of claim 24, further comprising directing colored fluid from the first ink source in the desired direction using the air from the outlet of the air directing implement.

26. The method of claim 24, further comprising connecting a second adaptor to the first end of the air directing implement, the second adaptor receiving and positioning a second ink source at a second predetermined position defined by a second predetermined distance from and a second predetermined angle with respect to the outlet of the air directing implement.

27. The method of claim 26, further comprising directing colored fluid from the second ink source in the desired direction using the air from the outlet of the air directing implement.
